(19) United States
(12) Patent Application Publication
(10) Pub. No.: US 2026/0219245 A1
(43) Pub. Date: Jul. 30, 2026

(54) TRAINED NEURAL NETWORK MODEL FOR PARAMETER-LESS PEAK DETECTION

(71) Applicant: Thermo Finnigan LLC, San Jose, CA (US)

(72) Inventors: Linda Xueying Lin, Fremont, CA (US); James Timothy Dillon, Austin, TX (US)

(21) Appl. No.: 19/141,590

(22) PCT Filed: Dec. 30, 2022
(86) PCT No.: PCT/US2022/054376

§ 371 Date: Jun. 20, 2025

(51) Int. Cl. G01N 30/86; G06N 3/0499

(52) U.S. Cl. CPC G01N 30/8631; G06N 3/0499

(57) ABSTRACT

Disclosed herein are scientific instrument support systems, as well as related methods, computing devices, and computer-readable media. For example, in some embodiments, a chromatography instrument support apparatus may include: first logic to receive a chromatogram data set; second logic to determine one or more peak locations for the chromatogram data set by processing the chromatogram data set through a machine-learning computational model to determine a plurality of input parameter values for a Gaussian curve fitting the chromatogram data set; and third logic to provide the one or more peak locations for further small molecule Liquid-Chromatography Mass Spectrometry (LC/MS) processing.

### BACKGROUND

Chromatography is a technique for the separation of constituents of a sample mixture that utilizes the differing properties of the constituents as they interact with other materials. Types of chromatography include gas chromatography and liquid chromatography, among others.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram of an example chromatography instrument support module for determining peak locations for a chromatogram data set, in accordance with various embodiments.

FIG. 2A is a flow diagram of an example method to determine peak locations for a chromatogram data set, in accordance with various embodiments.

FIG. 2B is a flow diagram of an example method of generating and selecting a machine-learning computational model for determining peak locations for a chromatogram data set, in accordance with various embodiments.

FIGS. 3A-3D depict example graphical representations for training a neural network to determining peak locations for a chromatogram data set, in accordance with various embodiments.

FIGS. 4A-4F depict graphical representations for performance comparison of various ways to train a neural network to determining peak locations for a chromatogram data set, in accordance with various embodiments.

FIG. 5 is an example of a graphical user interface that may be used in the performance of some or all of the support methods disclosed herein, in accordance with various embodiments.

FIG. 6 is a block diagram of an example computing device that may perform some or all of the chromatography instrument support methods disclosed herein, in accordance with various embodiments.

FIG. 7 is a block diagram of an example chromatography instrument support system in which some or all of the chromatography instrument support methods disclosed herein may be performed, in accordance with various embodiments.

### DETAILED DESCRIPTION

Disclosed herein are scientific instrument support systems, as well as related methods, computing devices, and computer-readable media. For example, in some embodiments, a chromatography instrument support apparatus may include: first logic to receive a chromatogram data set; second logic to determine one or more peak locations for the chromatogram data set by processing the chromatogram data set through a machine-learning computational model to determine a plurality of input parameter values for a Gaussian curve fitting the chromatogram data set; and third logic to provide the one or more peak locations for further small molecule Liquid-Chromatography Mass Spectrometry (LC/MS) processing.

The scientific instrument support embodiments disclosed herein may achieve improved performance relative to conventional approaches. As discussed in further detail below, untargeted metabolomics studies using LC/MS are generally characterized by their complex and challenging datasets that require a suit of algorithms to distill the data into useful information for the end-user. Two of the major challenges with LC/MS include: 1) improving the accuracy of results with increasingly complex samples, and 2) reducing the compute time of the data processing algorithms. In order to tackle these challenges, the described system employs a neural network assisted chromatographic peak detector for the LC/MS data processing pipeline. Moreover, many current data processing workflows include multiple stages of data analysis that aim to locate and identify the compounds among the vast amounts of instrument data produced by modern LC/MS instruments.

Accordingly, the chromatography instrument support embodiments disclosed herein may include deep learning technique with a feed forward neural network inside a chromatographic peak detector for metabolomic and small molecule LC/MS data processing that is used for applications in metabolomics and small molecule data. More specifically, in some embodiments, the described system employs a machine learning component to a peak detection algorithm to estimate parameter values for a Gaussian curve that fits the target data. In some embodiments, the peak detection algorithm includes an empirically transformed Gaussian function (ETG), a polynomial modified Gaussian function (PMG), a generalized exponentially modified Gaussian function (GEMG), or a hybrid of Gaussian and truncated exponential functions (EGH). In some embodiments, the system replaces a traditional multivariate optimization algorithm by employing a trained neural network to determine the parameter values for a Gaussian curve. The embodiments disclosed herein thus provide improvements to scientific instrument technology (e.g., improvements in the computer technology supporting such scientific instruments, among other improvements).

In some embodiments, the engine powering small molecule LC/MS data processing (small molecule workflow) is known as Component Elucidator (CE). Peak detection is a critical, optimization step in this workflow as it affects the downstream steps. In some embodiments, a peak detector used by CE includes parameter-less peak detection (PPD). Generally, PPD handles co-eluting peaks better than other detectors (e.g., Avalon, Genesis, and interactive chemical information system (ICIS); however, in some instances, PPD is computationally slower than the other peak detectors. In some embodiments, the described system attempts to fit a Gaussian curve to a chromatogram for PPD. This optimization step is the one of the bottlenecks for PPD performance. In some embodiments, the type of Gaussian curve employed includes four input parameters: retention time, peak width, peak height, and exponential decay factor.

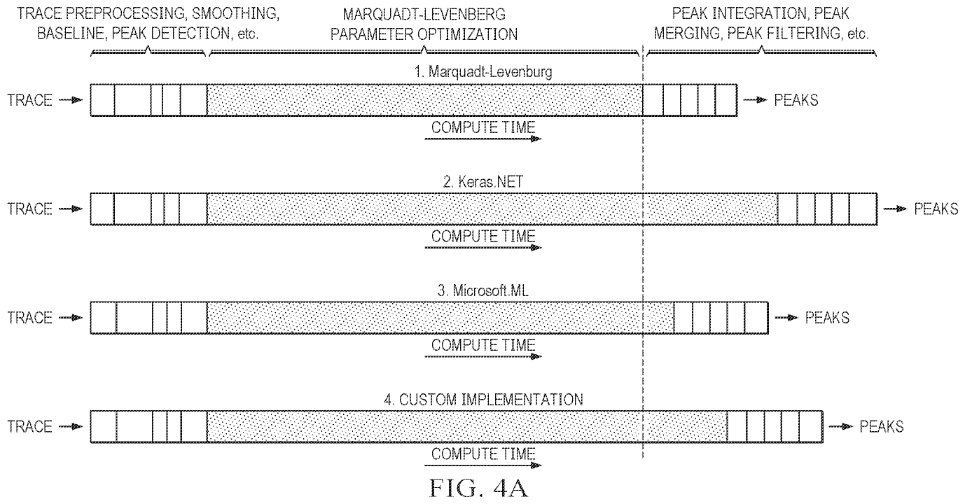

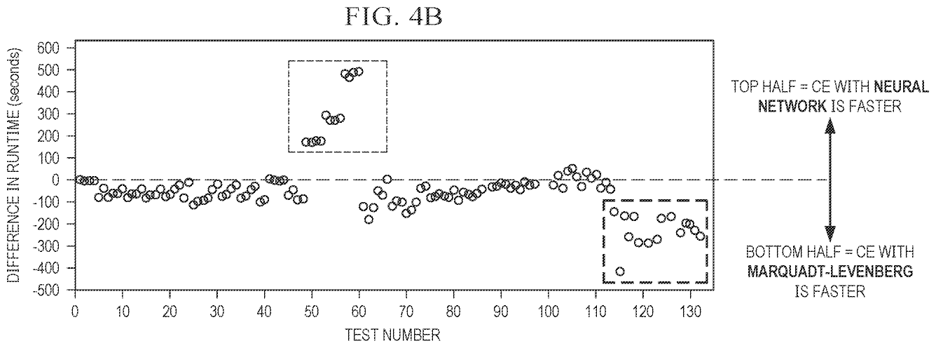

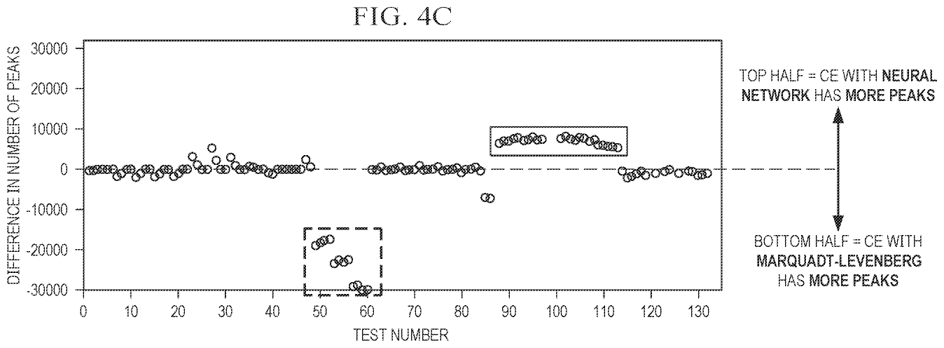

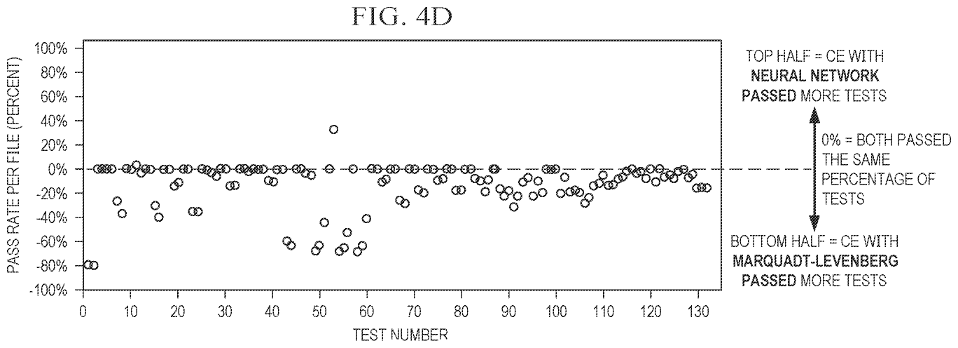

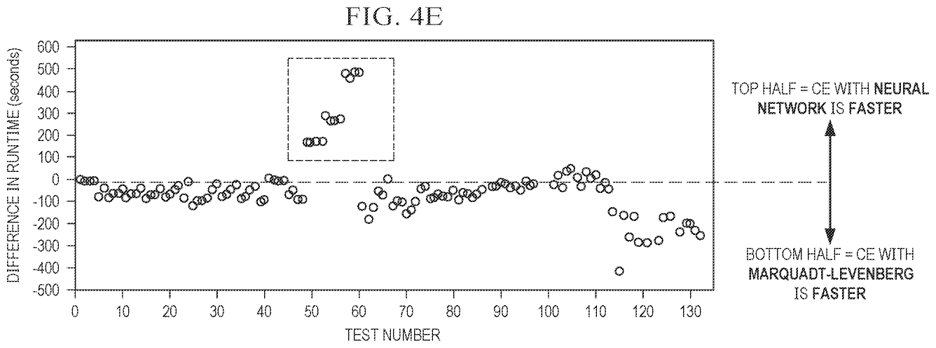

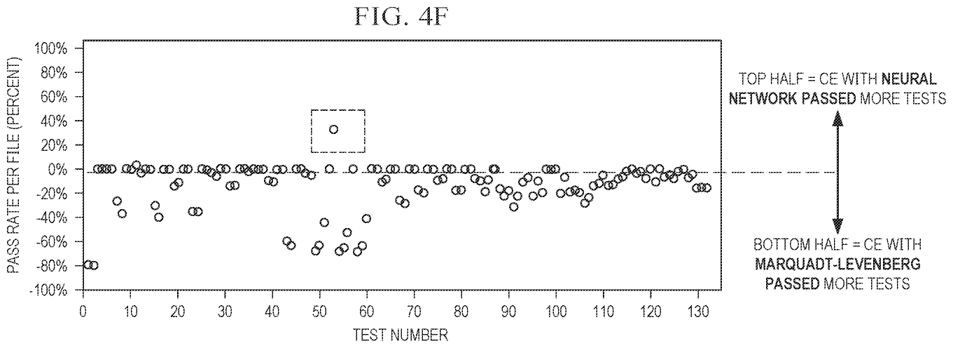

In some embodiments, the described system employs machine learning (e.g., via a trained neural network) to determine the input parameter values for the Gaussian curve to optimize PPD. In some embodiments, the system modifies PPD by employing a trained neural network instead of, for example, the Marquadt-Levenberg method to determine the input parameter values for the Gaussian curve and improve the accuracy or runtime of the peak detection step. While the below disclosure describes employing the trained neural network for peak detection within CE, the system can be employed for additional chromatographic peak models to, for example, deconvolute overlapped peaks of and smooth experimental peaks for the determination of statistical moments. In some embodiments, the described system employs a machine learning framework (e.g., Keras.NET, Microsoft.ML) to train a neural network model for PPD peak parameter determination (see FIGS. 4A-4F).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

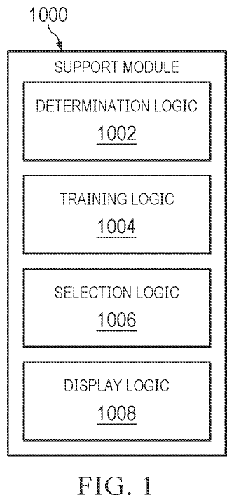

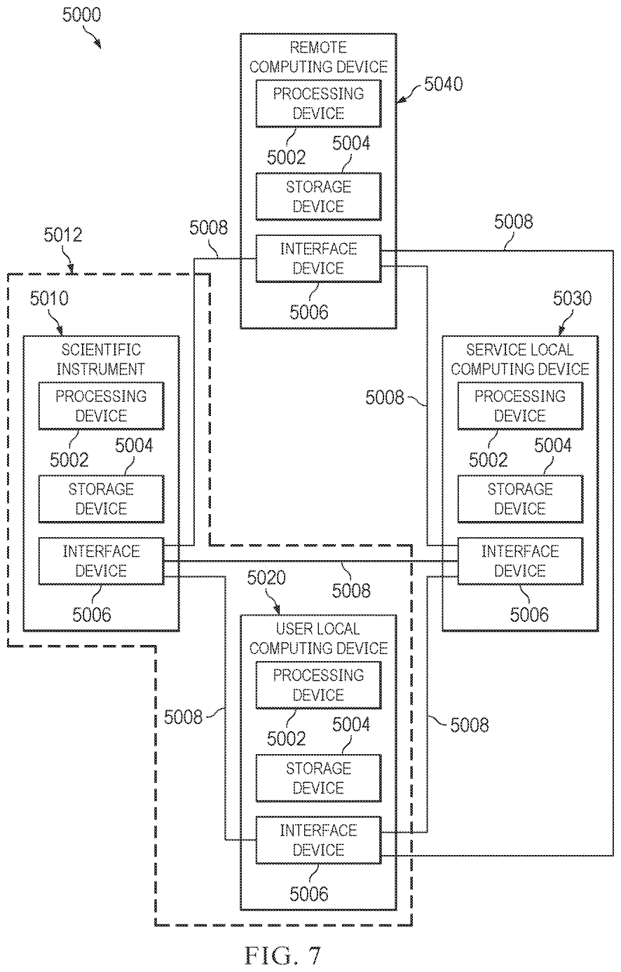

FIG. 1 is a block diagram of a chromatography instrument support module 1000 for automated peak detection (peak and baseline generation), in accordance with various embodiments. The chromatography instrument support module 1000 may be implemented by circuitry (e.g., including electrical and/or optical components), such as a programmed computing device. The logic of the chromatography instrument support module 1000 may be included in a single computing device or may be distributed across multiple computing devices that are in communication with each other as appropriate. Examples of computing devices that may, singly or in combination, implement the chromatography instrument support module 1000 are discussed herein with reference to the computing device 4000 of FIG. 6, and examples of systems of interconnected computing devices, in which the chromatography instrument support module 1000 may be implemented across one or more of the computing devices, is discussed herein with reference to the chromatography instrument support system 5000 of FIG. 7.

The chromatography instrument support module 1000 may include parameter values determination logic 1002, training logic 1004, model selection logic 1006, and chromatogram display logic 1008. As used herein, the term “logic” may include an apparatus that is to perform a set of operations associated with the logic. For example, any of the logic elements included in the support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform one or more functions associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

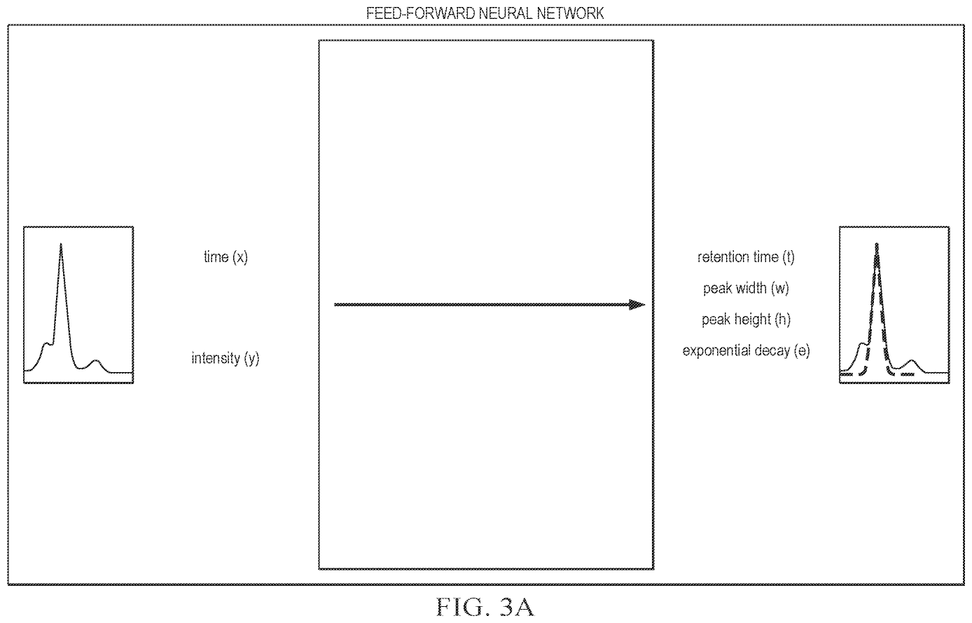

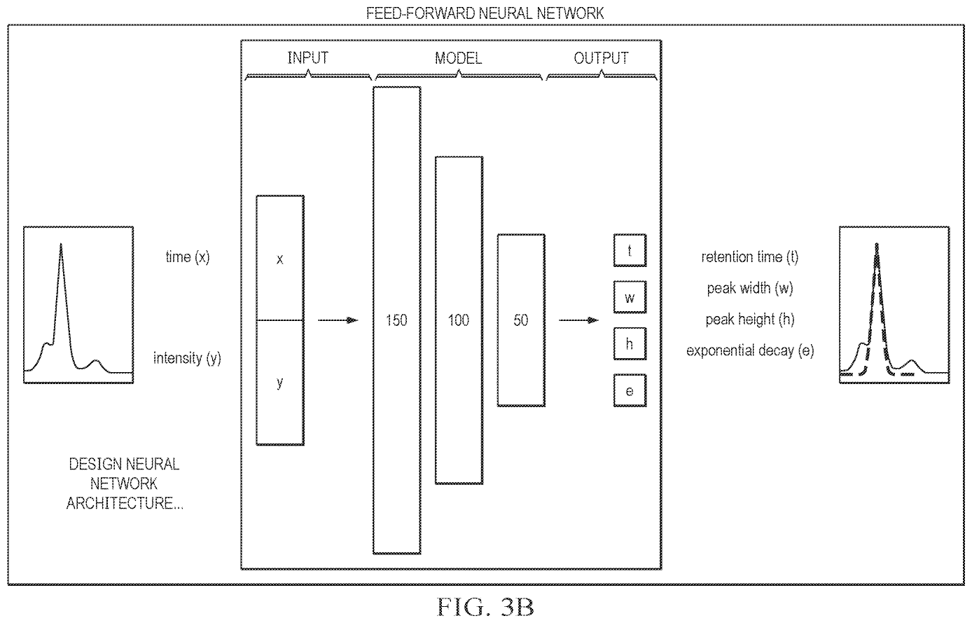

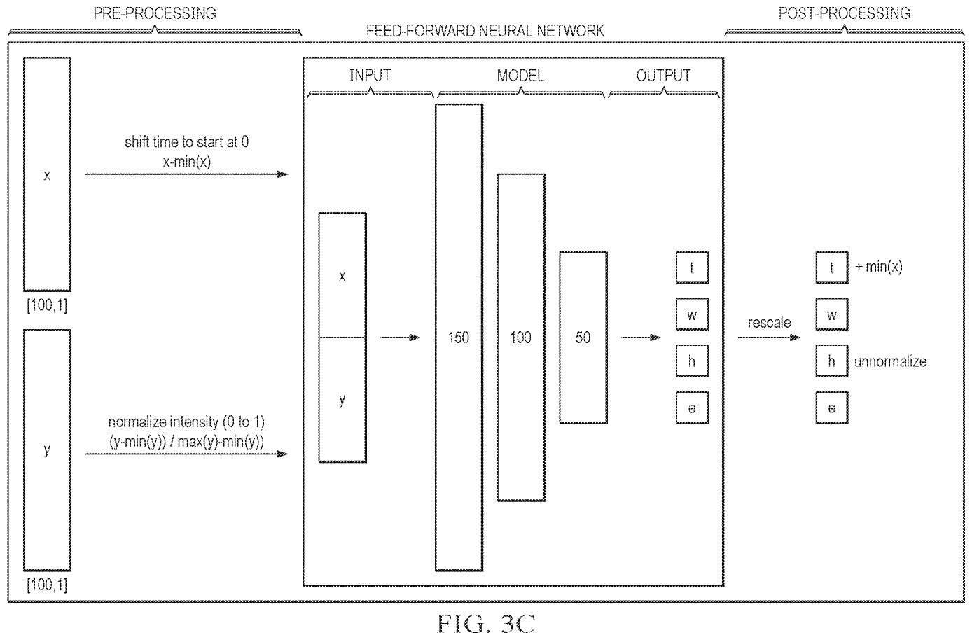

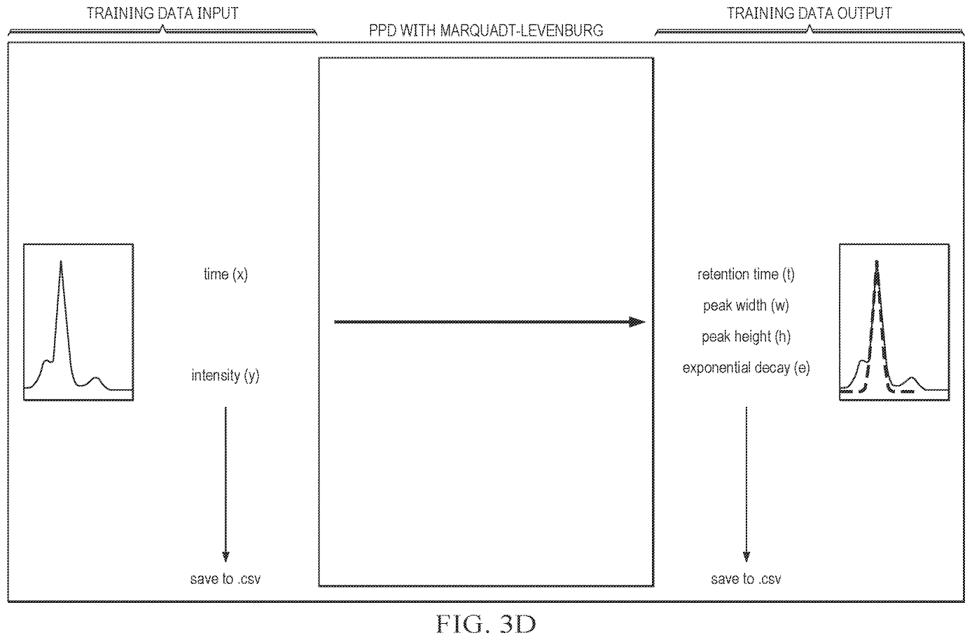

The parameter values determination logic 1002 may be configured to determine parameter values for a Gaussian curve that fits a chromatogram data set (as illustrated in FIG. 3A). The chromatogram data set may be data generated by a chromatography instrument, such as any of the chromatography instruments discussed herein. For example, the chromatogram data set may include capillary electrophoresis data, cation exchange data, hydrophobic interaction data, reversed-phase data, or size-exclusion data, among others.

In some embodiments, the parameter values determination logic 1002 employs a trained neural network to replace a traditional multivariate optimization algorithm to determine the parameter values for a Gaussian curve. In some embodiments, the parameter values determination logic 1002 attempts to fit a Gaussian curve to a chromatogram for PPD. This optimization step is the one of the bottlenecks for PPD performance. In some embodiments, the type of Gaussian curve employed includes four input parameters: retention time, peak width, peak height, and exponential decay factor. In some embodiments, the parameter values determination logic 1002 employs machine learning (e.g., via a trained neural network) to determine the input parameter values for the Gaussian curve to optimize PPD. As noted above, the parameter values determination logic 1002 may include a machine-learning computational model (see FIGS. 3A-3D) that outputs parameter values for a Gaussian curve that fits a chromatogram data set, and that is trained on data that has been provided by an individual or institution and reflects that individual's or institution's preferences for peak and baseline identification.

In some embodiments, the machine-learning computational model may be a neural network computational model that receives, as an input, chromatogram data set, and outputs parameter values for a Gaussian curve that fits the chromatogram data set. The architecture of the machine-learning computational model may take any of a number of forms, such as a neural network model (e.g., a convolutional neural network model). For example, the parameter values determination logic 1002 may include a machine-learning computational model with an architecture similar to that of the U-NET convolutional neural network, but with U-NET's two-dimensional convolutions (suitable for a two-dimensional input image) replaced by one-dimensional convolutions (suitable for a one-dimensional input chromatogram data array). Different kernel sizes (e.g., a kernel size between 3 and 20) and numbers of blocks (e.g., four blocks in the descending portion of the “U” of the U-NET architecture) may be used and/or adjusted as suitable. Training of the machine-learning computational model included in the parameter values determination logic 1002 is discussed further below with reference to the training logic 1004.

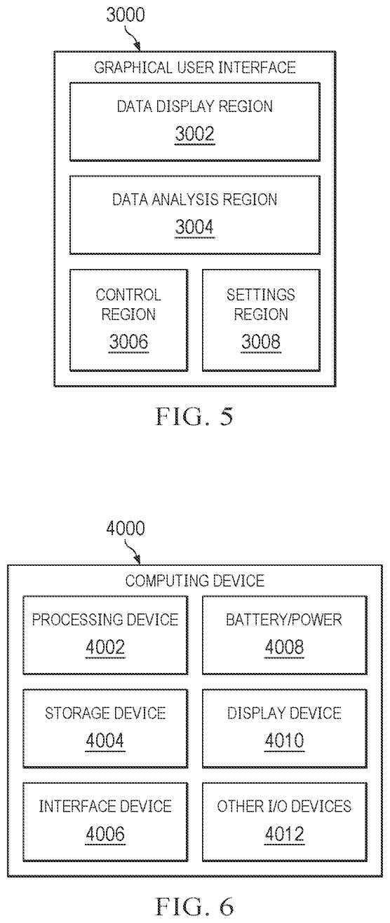

The training logic 1004 may be configured to initially train the machine-learning computational model used by the parameter values determination logic 1002 (e.g., on a body of training data including chromatogram data sets generated manually or otherwise using common separated values (csv) file and/or raw files), and to retrain the machine-learning computational model upon the receipt of additional chromatogram data sets. Any suitable training technique for machine-learning computational models may be implemented by the training logic 1004, such as a gradient descent process using suitable loss functions. In some embodiments, the training logic 1004 the output parameter values, to retrain the machine-learning computational model, may utilize dropout or other regularization methods, and may reserve some of the training data for use in validation and in assessing when to stop the retraining process. The training logic 1004 may perform such retraining on a regular chronological schedule (e.g., every week), after a certain number of confirmed chromatogram data sets are accumulated (e.g., 20), in accordance with any other suitable schedule, or at the command of a user (e.g., received via a GUI, such as the GUI 3000 of FIG. 5). In some embodiments, the training data for retraining of a machine-learning computational model may include a Network Common Data Format (NetCDF) file including the chromatogram data set (e.g., specifying an array of chromatogram signal values, a sampling rate value corresponding to the detection frequency of the chromatography instrument or a resampled frequency, and, optionally, an array of retention time values corresponding to the array of chromatogram signal values) and a plain text file containing information about the chromatogram data set.

The model selection logic 1006 may be configured to provide multiple machine-learning computational models that may be selectively utilized by the parameter values determination logic 1002 to determine parameter values for a Gaussian curve that fits a chromatogram data set. For example, one machine-learning computational model may be trained for analyzing sample mixtures of one type, while another machine-learning computational model may be trained for analyzing sample mixtures of a different type (and thus the different machine-learning computational models may be trained on different training data sets). The chromatogram display logic 1008 may provide to a user, through a GUI (such as the GUI 3000 of FIG. 5), an option to select the machine-learning computational model that they wish to use for a particular sample mixture from a set of stored machine-learning computational models (e.g., identified with different names) made available by the model selection logic 1006, and the selected machine-learning computational model may be used by the parameter values determination logic 1002 as part of determining parameter values for a Gaussian curve that fits a chromatogram data set. The model selection logic 1006 may also provide to a user, through a GUI (such as the GUI 3000 of FIG. 5), an option to create a new machine-learning computational model; the model selection logic 1006 may prompt a user to enter a name or other identifier for the new machine-learning computational model, and to specify data that can be used to train the new machine-learning computational model. In some embodiments, the model selection logic 1006 may require a threshold amount of training data before training of a new machine-learning computational model may proceed, and once trained, the new machine-learning computational model may be available for selection via the model selection logic 1006.

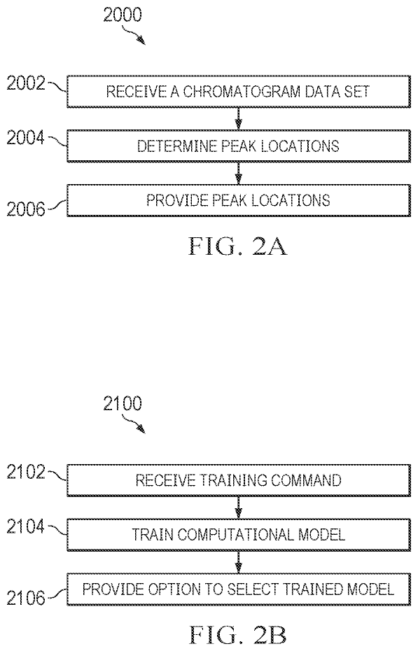

FIGS. 2A and 2B are flow diagrams of a method 2000 and 2100, respectively, of performing support operations, in accordance with various embodiments. Although the operations of the methods 2000 and 2100 may be illustrated with reference to particular embodiments disclosed herein (e.g., the scientific instrument support modules 1000 discussed herein with reference to FIG. A, the GUI 3000 discussed herein with reference to FIG. 5, the computing devices 4000 discussed herein with reference to FIG. 6, and/or the scientific instrument support system 5000 discussed herein with reference to FIG. 7), the methods 2000 and 2100 may be used in any suitable setting to perform any suitable support operations. Operations are illustrated once each and in a particular order in FIG. 2A and FIG. 2B, but the operations may be reordered and/or repeated as desired and appropriate (e.g., different operations performed may be performed in parallel, as suitable).

For method 2000, at 2002, first operations may be performed. For example, a support module 1000 may perform the operations of 2002 (e.g., via receiving logic not shown in FIG. 1). The first operations may include receiving a chromatogram data set.

At 2004, second operations may be performed. For example, the determination logic 1002 of the support module 1000 may perform the operations of 2004. The second operations may include determining one or more peak locations for the chromatogram data set by processing the chromatogram data set through a machine-learning computational model to determine a plurality of input parameter values for a Gaussian curve fitting the chromatogram data set.

At 2006, third operations may be performed. For example, the display logic 1008 of a support module 1000 may perform the operations of 2006. The third operations may include providing the one or more peak locations for further small molecule LC/MS processing.

For method 2100, at 2102, first operations may be performed. For example, the receiving logic (described above) of a support module 1000 may perform the operations of 2002. The first operations may include receiving a command to train a machine-learning computational model. In some embodiments, the command includes an identification of multiple chromatogram data sets and a plurality of input parameter values for a Gaussian curve fitting each of the chromatogram data sets for training the machine-learning computational model.

At 2104, second operations may be performed. For example, the training logic 1004 of a support module 1000 may perform the operations of 2104. The second operations may include initially training the machine-learning computational model based on the multiple chromatogram data sets and the input parameter values for the Gaussian curve fitting each of the chromatogram data sets. In some embodiments, the machine-learning computational model is to output a plurality of input parameter values for a Gaussian curve fitting an input chromatogram data set At 2106, third operations may be performed. For example, the selection logic 1006 of a support module 1000 may perform the operations of 2106. The third operations may include providing, after initial training, an option to select the machine-learning computational model for application to a subsequent chromatogram data set.

The scientific instrument support methods disclosed herein may include interactions with a human user (e.g., via the user local computing device 5020 discussed herein with reference to FIG. 7). These interactions may include providing information to the user (e.g., information regarding the operation of a scientific instrument such as the scientific instrument 5010 of FIG. 7, information regarding a sample being analyzed or other test or measurement performed by a scientific instrument, information retrieved from a local or remote database, or other information) or providing an option for a user to input commands (e.g., to control the operation of a scientific instrument such as the scientific instrument 5010 of FIG. 7, or to control the analysis of data generated by a scientific instrument), queries (e.g., to a local or remote database), or other information. In some embodiments, these interactions may be performed through a graphical user interface (GUI) that includes a visual display on a display device (e.g., the display device 4010 discussed herein with reference to FIG. 5) that provides outputs to the user and/or prompts the user to provide inputs (e.g., via one or more input devices, such as a keyboard, mouse, trackpad, or touchscreen, included in the other I/O devices 4012 discussed herein with reference to FIG. 5). The scientific instrument support systems disclosed herein may include any suitable GUIs for interaction with a user.

FIG. 5 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 6) of a computing device (e.g., the computing device 4000 discussed herein with reference to FIG. 6) of a scientific instrument support system (e.g., the scientific instrument support system 5000 discussed herein with reference to FIG. 7), and a user may interact with the GUI 3000 using any suitable input device (e.g., any of the input devices included in the other I/O devices 4012 discussed herein with reference to FIG. 6) and input technique (e.g., movement of a cursor, motion capture, facial recognition, gesture detection, voice recognition, actuation of buttons, etc.).

The GUI 3000 may include a data display region 3002, a data analysis region 3004, a scientific instrument control region 3006, and a settings region 3008. The particular number and arrangement of regions depicted in FIG. 5 is simply illustrative, and any number and arrangement of regions, including any desired features, may be included in a GUI 3000.

The data display region 3002 may display data generated by a scientific instrument (e.g., the scientific instrument 5010 discussed herein with reference to FIG. 7). For example, the data display region 3002 may provide to a user an option to select the machine-learning computational model that they wish to use for a particular sample mixture from a set of stored machine-learning computational models made available by the model selection logic 1006, and the selected machine-learning computational model may be used by the parameter values determination logic 1002 as part of determining parameter values for a Gaussian curve that fits a chromatogram data set.

The data analysis region 3004 may display the results of data analysis (e.g., the results of analyzing the data illustrated in the data display region 3002 and/or other data). For example, the data analysis region 3004 may display the parameter values determined by the determination logic 1002. In some embodiments, the data display region 3002 and the data analysis region 3004 may be combined in the GUI 3000 (e.g., to include data output from a scientific instrument, and some analysis of the data, in a common graph or region).

The scientific instrument control region 3006 may include options that allow the user to control a scientific instrument (e.g., the scientific instrument 5010 discussed herein with reference to FIG. 7). The settings region 3008 may include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 6, sending data to another user, labeling data, etc.).

As noted above, the scientific instrument support module 1000 may be implemented by one or more computing devices. FIG. 6 is a block diagram of a computing device 4000 that may perform some or all of the scientific instrument support methods disclosed herein, in accordance with various embodiments. In some embodiments, the scientific instrument support module 1000 may be implemented by a single computing device 4000 or by multiple computing devices 4000. Further, as discussed below, a computing device 4000 (or multiple computing devices 4000) that implements the scientific instrument support module 1000 may be part of one or more of the scientific instrument 5010, the user local computing device 5020, the service local computing device 5030, or the remote computing device 5040 of FIG. 7.

The computing device 4000 of FIG. 6 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 6, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUS), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 7 is a block diagram of an example scientific instrument support system 5000 in which some or all of the scientific instrument support methods disclosed herein may be performed, in accordance with various embodiments. The scientific instrument support modules and methods disclosed herein (e.g., the scientific instrument support module 1000 of FIG. A and the method 2000 of FIG. B) may be implemented by one or more of the scientific instrument 5010, the user local computing device 5020, the service local computing device 5030, or the remote computing device 5040 of the scientific instrument support system 5000.

Any of the scientific instrument 5010, the user local computing device 5020, the service local computing device 5030, or the remote computing device 5040 may include any of the embodiments of the computing device 4000 discussed herein with reference to FIG. 6, and any of the scientific instrument 5010, the user local computing device 5020, the service local computing device 5030, or the remote computing device 5040 may take the form of any appropriate ones of the embodiments of the computing device 4000 discussed herein with reference to FIG. 6.

The scientific instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 4, and the processing devices 5002 included in different ones of the scientific instrument 5010, the user local computing device 5020, the service local computing device 5030, or the remote computing device 5040 may take the same form or different forms. The storage device 5004 may take any suitable form, including the form of any of the storage devices 5004 discussed herein with reference to FIG. 4, and the storage devices 5004 included in different ones of the scientific instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 4, and the interface devices 5006 included in different ones of the scientific instrument 5010, the user local computing device 5020, the service local computing device 5030, or the remote computing device 5040 may take the same form or different forms.

The scientific instrument 5010, the user local computing device 5020, the service local computing device 5030, and the remote computing device 5040 may be in communication with other elements of the scientific instrument support system 5000 via communication pathways 5008. The communication pathways 5008 may communicatively couple the interface devices 5006 of different ones of the elements of the scientific instrument support system 5000, as shown, and may be wired or wireless communication pathways (e.g., in accordance with any of the communication techniques discussed herein with reference to the interface devices 4006 of the computing device 4000 of FIG. 6). The particular scientific instrument support system 5000 depicted in FIG. 7 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the scientific instrument 5010, but may instead communicate with the scientific instrument 5010 via the communication pathway 5008 between the service local computing device 5030 and the user local computing device 5020 and the communication pathway 5008 between the user local computing device 5020 and the scientific instrument 5010.

The user local computing device 5020 may be a computing device (e.g., in accordance with any of the embodiments of the computing device 4000 discussed herein) that is local to a user of the scientific instrument 5010. In some embodiments, the user local computing device 5020 may also be local to the scientific instrument 5010, but this need not be the case; for example, a user local computing device 5020 that is in a user's home or office may be remote from, but in communication with, the scientific instrument 5010 so that the user may use the user local computing device 5020 to control and/or access data from the scientific instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the scientific instrument 5010. For example, the service local computing device 5030 may be local to a manufacturer of the scientific instrument 5010 or to a third-party service company. In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 may utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 may be a computing device (e.g., in accordance with any of the embodiments of the computing device 4000 discussed herein) that is remote from the scientific instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010.

In some embodiments, one or more of the elements of the scientific instrument support system 5000 illustrated in FIG. 7 may not be present. Further, in some embodiments, multiple ones of various ones of the elements of the scientific instrument support system 5000 of FIG. 7 may be present. For example, a scientific instrument support system 5000 may include multiple user local computing devices 5020 (e.g., different user local computing devices 5020 associated with different users or in different locations). In another example, a scientific instrument support system 5000 may include multiple scientific instruments 5010, all in communication with service local computing device 5030 and/or a remote computing device 5040; in such an embodiment, the service local computing device 5030 may monitor these multiple scientific instruments 5010, and the service local computing device 5030 may cause updates or other information may be “broadcast” to multiple scientific instruments 5010 at the same time. Different ones of the scientific instruments 5010 in a scientific instrument support system 5000 may be located close to one another (e.g., in the same room) or farther from one another (e.g., on different floors of a building, in different buildings, in different cities, etc.). In some embodiments, a scientific instrument 5010 may be connected to an Internet-of-Things (IoT) stack that allows for command and control of the scientific instrument 5010 through a web-based application, a virtual or augmented reality application, a mobile application, and/or a desktop application. Any of these applications may be accessed by a user operating the user local computing device 5020 in communication with the scientific instrument 5010 by the intervening remote computing device 5040. In some embodiments, a scientific instrument 5010 may be sold by the manufacturer along with one or more associated user local computing devices 5020 as part of a local scientific instrument computing unit 5012.

The following paragraphs provide various examples of the embodiments disclosed herein.

Example 1 is a chromatography support apparatus including first logic to receive a chromatogram data set; second logic to determine one or more peak locations for the chromatogram data set by processing the chromatogram data set through a machine-learning computational model to determine a plurality of input parameter values for a Gaussian curve fitting the chromatogram data set; and third logic to provide the one or more peak locations for further small molecule LC/MS processing.

Example 2 includes the subject matter of Example 1, and further includes: fourth logic to cause the display of the one or more peak locations and with the display of the chromatogram data set.

Example 3 includes the subject matter of any of Examples 1 and 2, and further specifies that the machine-learning computational model comprises a trained neural network.

Example 4 includes the subject matter of any of Examples 1-3, and further specifies that the machine-learning computational model comprises a trained feed forward neural network.

Example 5 includes the subject matter of any of Examples 1-4, and further specifies that the one or more peak locations are provided to deconvolute overlapped peaks or smooth experimental peaks for a determination of statistical moments.

Example 6 includes the subject matter of any of Examples 1-5, and further specifies that the second logic includes a peak detection algorithm.

Example 7 includes the subject matter of any of Examples 1-6, and further specifies that the peak detection algorithm includes an ETG, a PMG, a GEMG, or an EGH.

Example 8 includes the subject matter of any of Examples 1-7, and further specifies that the chromatogram data set includes a time value and an intensity value.

Example 9 includes the subject matter of any of Examples 1-8, and further specifies that the input parameter values include retention time, peak width, peak height, and exponential decay.

Example 10 includes the subject matter of any of Examples 1-9, and further specifies that the first logic, the second logic, and the third logic are implemented by a common computing device.

Example 11 is a chromatography support apparatus including first logic to receive a command to train a machine-learning computational model, where the command includes an identification of multiple chromatogram data sets and a plurality of input parameter values for a Gaussian curve fitting each of the chromatogram data sets for training the machine-learning computational model; second logic to initially train the machine-learning computational model based on the multiple chromatogram data sets and the input parameter values for the Gaussian curve fitting each of the chromatogram data sets, where the machine-learning computational model is to output a plurality of input parameter values for a Gaussian curve fitting an input chromatogram data set; and third logic to provide, after initial training, an option to select the machine-learning computational model for application to a subsequent chromatogram data set.

Example 12 includes the subject matter of Example 11, and further specifies that an input to the machine-learning computational model comprises a one-dimensional array of chromatogram data.

Example 13 includes the subject matter of any of Examples 11 and 12, and further specifies that the machine-learning computational model is a first machine-learning computational model.

Example 14 includes the subject matter of any of Examples 11-13, and further specifies that the first logic is to receive a command to train a second machine-learning computational model.

Example 15 includes the subject matter of any of Examples 11-14, and further specifies that the command to train the second machine-learning computational model includes an identification of multiple chromatogram data sets and the input parameter values for the Gaussian curve fitting each of the chromatogram data sets for training the second machine-learning computational model.

Example 16 includes the subject matter of any of Examples 11-15, and further specifies that the multiple chromatogram data sets and the input parameter values for the Gaussian curve fitting each of the chromatogram data sets used to train the second machine-learning computational model are different from the multiple chromatogram data sets and the input parameter values for the Gaussian curve fitting each of the chromatogram data sets used to train the first machine-learning computational model.

Example 17 includes the subject matter of any of Examples 11-16, and further specifies that the second logic is to provide a selection of which of multiple computational models, including the first machine-learning computational model and the second machine-learning computational model, to use to analyze the subsequent chromatogram data set.

Example 18 includes the subject matter of any of Examples 11-17, and further specifies that the second logic is also to provide selectable options for non-machine-learning computational models to apply to the subsequent chromatogram data set.

Example 19 is a method for scientific instrument support executed by one or more processing devices. The method includes receiving a chromatogram data set; determining one or more peak locations for the chromatogram data set by processing the chromatogram data set through a machine-learning computational model to determine a plurality of input parameter values for a Gaussian curve fitting the chromatogram data set; and providing the one or more peak locations for further small molecule Liquid-Chromatography Mass Spectrometry (LC/MS) processing.

Example 20 includes the subject matter of Example 19, and further includes: fourth logic to cause the display of the one or more peak locations and with the display of the chromatogram data set.

Example 21 includes the subject matter of any of Examples 19 and 20, and further specifies that the machine-learning computational model comprises a trained neural network.

Example 22 includes the subject matter of any of Examples 19-21, and further specifies that the machine-learning computational model comprises a trained feed forward neural network.

Example 23 includes the subject matter of any of Examples 19-22, and further specifies that the one or more peak locations are provided to deconvolute overlapped peaks or smooth experimental peaks for a determination of statistical moments.

Example 24 includes the subject matter of any of Examples 19-23, and further specifies that the second logic includes a peak detection algorithm.

Example 25 includes the subject matter of any of Examples 19-24, and further specifies that the peak detection algorithm includes an ETG, a PMG, a GEMG, or an EGH.

Example 26 includes the subject matter of any of Examples 19-25, and further specifies that the chromatogram data set includes a time value and an intensity value.

Example 27 includes the subject matter of any of Examples 19-26, and further specifies that the input parameter values include retention time, peak width, peak height, and exponential decay.

Example 28 includes the subject matter of any of Examples 19-27, and further specifies that the first logic, the second logic, and the third logic are implemented by a common computing device.

1. A chromatography support apparatus, comprising:
first logic to receive a chromatogram data set;
second logic to determine one or more peak locations for the chromatogram data set by processing the chromatogram data set through a machine-learning computational model to determine a plurality of input parameter values for a Gaussian curve fitting the chromatogram data set; and
third logic to provide the one or more peak locations for further small molecule Liquid-Chromatography Mass Spectrometry (LC/MS) processing.

2. The chromatography support apparatus of claim 1, comprising fourth logic to cause the display of the one or more peak locations and with the display of the chromatogram data set.

3. The chromatography support apparatus of claim 1, wherein the machine-learning computational model comprises a trained neural network.

4. The chromatography support apparatus of claim 3, wherein the machine-learning computational model comprises a trained feed forward neural network.

5. The chromatography support apparatus of claim 1, wherein the one or more peak locations are provided to deconvolute overlapped peaks or smooth experimental peaks for a determination of statistical moments.

6. The chromatography support apparatus of claim 1, wherein the second logic includes a peak detection algorithm.

7. The chromatography support apparatus of claim 6, wherein the peak detection algorithm includes an empirically transformed Gaussian function (ETG), a polynomial modified Gaussian function (PMG), a generalized exponentially modified Gaussian function (GEMG), or a hybrid of Gaussian and truncated exponential functions (EGH).

8. The chromatography support apparatus of claim 1, wherein the chromatogram data set includes a time value and an intensity value.

9. The chromatography support apparatus of claim 1, wherein the input parameter values include retention time, peak width, peak height, and exponential decay.

10. The chromatography support apparatus of claim 1, wherein the first logic, the second logic, and the third logic are implemented by a common computing device.

11. A chromatography support apparatus, comprising:
first logic to receive a command to train a machine-learning computational model, wherein the command includes an identification of multiple chromatogram data sets and a plurality of input parameter values for a Gaussian curve fitting each of the chromatogram data sets for training the machine-learning computational model;
second logic to initially train the machine-learning computational model based on the multiple chromatogram data sets and the input parameter values for the Gaussian curve fitting each of the chromatogram data sets, wherein the machine-learning computational model is to output a plurality of input parameter values for a Gaussian curve fitting an input chromatogram data set; and
third logic to provide, after initial training, an option to select the machine-learning computational model for application to a subsequent chromatogram data set.

12. The chromatography support apparatus of claim 11, wherein an input to the machine-learning computational model comprises a one-dimensional array of chromatogram data.

13. The chromatography support apparatus of claim 11, wherein the machine-learning computational model is a first machine-learning computational model, wherein the first logic is to receive a command to train a second machine-learning computational model, wherein the command to train the second machine-learning computational model includes an identification of multiple chromatogram data sets and the input parameter values for the Gaussian curve fitting each of the chromatogram data sets for training the second machine-learning computational model.

14. The chromatography support apparatus of claim 13, wherein the multiple chromatogram data sets and the input parameter values for the Gaussian curve fitting each of the chromatogram data sets used to train the second machine-learning computational model are different from the multiple chromatogram data sets and the input parameter values for the Gaussian curve fitting each of the chromatogram data sets used to train the first machine-learning computational model.

15. The chromatography support apparatus of claim 13, wherein the second logic is to provide a selection of which of multiple computational models, including the first machine-learning computational model and the second machine-learning computational model, to use to analyze the subsequent chromatogram data set.

16. The chromatography support apparatus of claim 13, wherein the second logic is also to provide selectable options for non-machine-learning computational models to apply to the subsequent chromatogram data set.

17. A method for scientific instrument support executed by one or more processing devices, comprising:
receiving a chromatogram data set;
determining one or more peak locations for the chromatogram data set by processing the chromatogram data set through a machine-learning computational model to determine a plurality of input parameter values for a Gaussian curve fitting the chromatogram data set; and
providing the one or more peak locations for further small molecule Liquid-Chromatography Mass Spectrometry (LC/MS) processing.

18. The method of claim 17, comprising:
displaying the one or more peak locations and the chromatogram data set.

19. The method of claim 17, wherein the machine-learning computational model comprises a trained neural network.

20. The method of claim 17, wherein the one or more peak locations are provided to deconvolute overlapped peaks or smooth experimental peaks for a determination of statistical moments.
